(19) United States
(12) Patent Application Publication
(10) Pub. No.: US 2019/0039556 A1
(43) Pub. Date: Feb. 7, 2019

(54) Folded Airbag For Consistent Inflation

(71) Applicant: Ford Global Technologies, LLC, Dearborn, MI (US)

(72) Inventor: Pardeep Kumar Jindal, Canton, MI (US)

(73) Assignee: Ford Global Technologies, LLC, Dearborn, MI (US)

(21) Appl. No.: 15/669,764

(22) Filed: Aug. 4, 2017

(51) Int. Cl. B60R 21/237

(52) U.S. Cl. CPC B60R 21/237; B60R 21/239; B60R 2021/2375

(57) ABSTRACT

An airbag includes a panel foldable to a storage position. The panel includes a top, a bottom spaced from the top along an axis, and sides spaced from each other and extending from the top to the bottom. The panel includes a first stack of pleats extending from one of the sides to the other of the sides along the top, and a second stack of pleats extending from one of the sides to the other of the sides along the bottom. The panel includes a first portion extending from the axis to one side and a second portion extending from the axis to the other side. The first portion and the second portion, in the storage position, are each folded along a first fold towards the axis and along a second fold away from the axis.

### BACKGROUND

A vehicle may include an airbag folded and stored in the vehicle in a storage position. The airbag may be inflatable from the storage position to an inflated position to absorb energy from an occupant during a vehicle impact. The airbag may be stored in the vehicle such that the airbag in the inflated position is between the occupant and vehicle components, e.g., the instrument panel.

FIG. 1 shows an example of a prior art airbag 5 being inflated from the storage position to the inflated position. As shown in FIG. 1, as the prior art airbag 5 inflates prior to reaching the inflation position, the surface of the airbag 5 closest to the occupant can have an inconsistent shape.

### BRIEF DESCRIPTION OF THE DRAWINGS

FIG. 1 is a side view of the vehicle including the prior art airbag of FIG. 1A during inflation from the storage position to an inflated position.

FIG. 2A is a side view of a vehicle including a seat spaced from an instrument panel supporting an airbag in a storage position.

FIG. 2B is a side view of the vehicle including the airbag of FIG. 2A during inflation from the storage position to the inflated position.

FIG. 2C is a side view of the vehicle including the airbag of FIG. 2A in the inflated position.

FIG. 3 is a perspective view of the airbag of FIG. 2A including a panel having a top, a bottom spaced from the top along an axis, and sides spaced from each other and extending from the top to the bottom.

FIG. 4 is cross-sectional view of FIG. 3 along the axis of the airbag showing a first stack of pleats along the top and a second stack of pleats along the bottom.

FIG. 5 is a perspective view of a first portion and a second portion of the panel each being folded along a first fold.

FIG. 6 is a perspective view of the first portion and the second portion of the panel each being folded along a second fold.

FIG. 7 is a perspective view of the top of the panel being rolled along the axis towards the bottom of the panel.

FIG. 8A is a perspective view of the bottom of the panel being rolled along the axis towards the top of the panel in the same direction as the top.

FIG. 8B is a perspective view of the bottom of the panel being rolled along the axis towards the top of the panel in an opposite direction than the top.

FIG. 8C is a perspective view of the top of the panel being rolled to the bottom of the panel

FIG. 9A is a perspective view of the airbag of FIG. 8A in the storage position.

FIG. 9B is a perspective view of the airbag of FIG. 8B in the storage position.

FIG. 9C is a perspective view of the airbag of FIG. 8C in the storage position.

FIG. 10 is a flow diagram showing the steps of a method to fold the airbag of FIG. 2A.

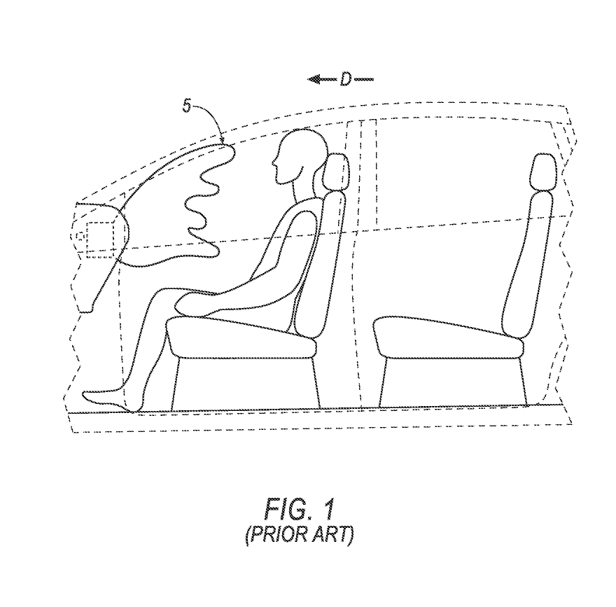

### DETAILED DESCRIPTION

An airbag includes a panel foldable to a storage position. The panel includes a top, a bottom spaced from the top along an axis, and sides spaced from each other and extending from the top to the bottom. The panel includes a first stack of pleats extending from one of the sides to the other of the sides along the top, and a second stack of pleats extending from one of the sides to the other of the sides along the bottom. The panel includes a first portion extending from the axis to one side and a second portion extending from the axis to the other side. The first portion and the second portion, in the storage position, are each folded along a first fold towards the axis and along a second fold away from the axis.

The top of the panel may be rolled along the axis towards the bottom of the panel. The bottom of the panel may be rolled along the axis towards the top of the panel. The top and the bottom of the panel may be rolled in the same rotational direction along the axis. The top and the bottom of the panel may be rolled in opposite rotational directions along the axis.

Each of the first folds and the second folds may extend along the axis from the top to the bottom of the panel.

The second fold of the first portion may be disposed between the first fold of the first portion and one side, and the second fold of the second portion may be disposed between the first fold of the second portion and the other side.

In the storage position, the first portion and the second portion may each include a first segment extending from the axis to the first fold, a second segment extending from the first fold to the second fold, and a third segment extending from the second fold away from the axis. The second segment may be sandwiched between the first segment and the third segment.

The airbag may include vents disposed on each side of the panel.

A method includes providing an airbag having a panel including a top, a bottom spaced from the top along an axis, and sides spaced from each other and extending from the bottom to the top. The panel including a first stack of pleats extending from one side to the other side along the top and a second stack of pleats extending from one side to the other side along the bottom. Folding a first portion of the panel towards the axis along a first fold disposed between the axis and one side, and folding the first portion of the panel away from the axis along a second fold disposed between the first fold and one side. Folding a second portion of the panel towards the axis along a first fold disposed between the axis and other side, and folding the second portion of the panel away from the axis along a second fold disposed between the first fold and other side.

The method may include rolling the top of the panel along the axis towards the bottom of the panel. The method may include rolling the bottom of the panel along the axis towards the top of the panel.

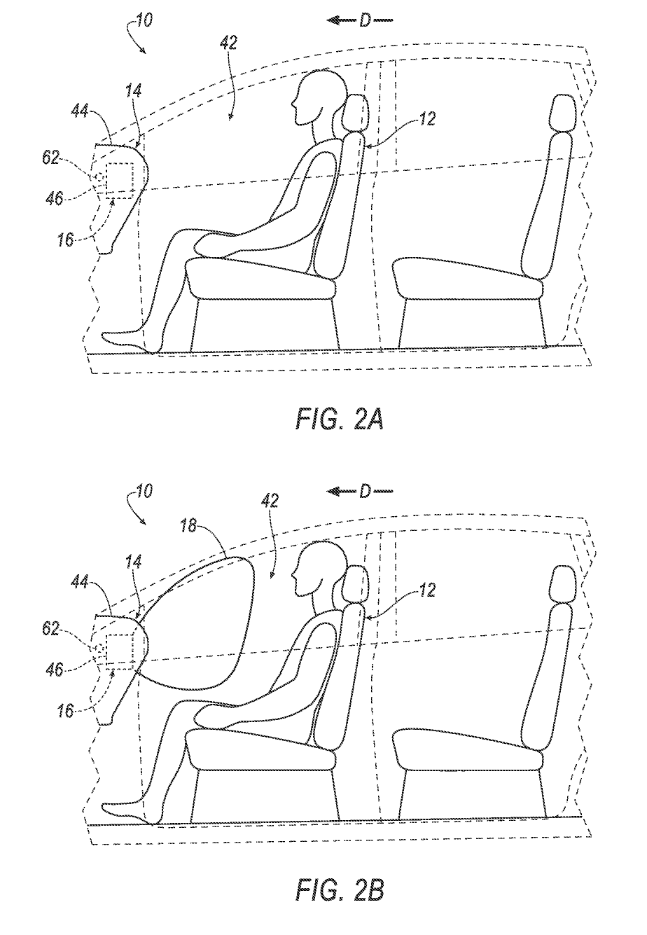

With reference to the Figures, wherein like numerals indicate like parts throughout the several views, a vehicle 10 is generally shown. The vehicle 10 includes a seat 12, a reaction surface 14 spaced from the seat 12 in a vehicle fore-and-aft direction D, and an airbag assembly 16, which includes an airbag 18, supported on the reaction surface 14. During a vehicle impact, the airbag 18 may be inflatable from a storage position, shown in Figure and 2A, to an inflated position, as shown in FIG. 2C. During the vehicle impact, an occupant may be forced into the airbag 18 in the inflated position. The airbag 18 may provide coverage so as to absorb the energy of the occupant and reduce the likelihood of injury. During the vehicle impact, the airbag 18 may slow or stop the head and/or the knees of the occupant from impacting vehicle components.

Some vehicle impacts, e.g., side impact, frontal offset impacts, far side oblique impact, near side oblique impact, roll-overs, etc., may cause occupants to move at an angle relative to the airbag 18. As set forth below, the airbag 18 may be folded in the storage position to both satisfy packaging requirements of the vehicle 10 and to consistently inflate from the storage position to the inflated position to provide maximum coverage of the occupant during the vehicle impact. For example, as shown in FIG. 2B, during inflation from the storage position to the inflated position, the surface of the airbag 18 closest to the occupant consistently moves toward the inflated position, e.g., is generally smooth. This consistent inflation of the surface of the airbag 18 closest to the occupant may increase the likelihood that the airbag 18 is positioned to impact the occupant regardless of the position of the occupant, e.g., if the occupant is out of position.

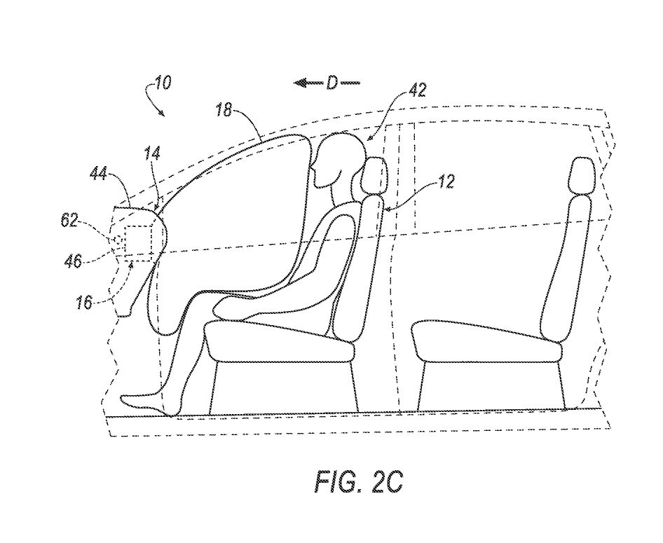

Specifically, with reference to FIGS. 3-9C, the airbag 18 includes a panel 20 foldable to the storage position. The panel 20 includes a top 22, a bottom 24 spaced from the top 22 along an axis A, and sides 26, 28 spaced from each other and extending from the top 22 to the bottom 24. The panel 20 includes a first stack of pleats 30 extending from one of the sides 26, 28 to the other of the sides 26, 28 along the top 22 of the panel 20, and a second stack of pleats 32 extending from one of the sides 26, 28 to the other of the sides 26, 28 along the bottom 24 of the panel 20. The panel 20 includes a first portion 34 extending from the axis A to one side 26 and a second portion 36 extending from the axis A to the other side 28. The first portion 34 and the second portion 36, in the storage position, each folded along a first fold 38 towards the axis A and along a second fold 40 away from the axis A. As the airbag 18 inflates from the storage position to the inflated position, the airbag 18 may unfold and extend towards the occupant of the seat 12, as shown in FIG. 2B. When the airbag 18 unfolds along the first fold 38 and the second fold 40, the panel 20 may consistently inflate to the inflated position with the surface of the airbag 18 closest to the occupant being generally smooth. The first fold 38 and the second fold 40 of each portion 34, 36 may provide more repeatable coverage during inflation such that during inflation the panel 20 may provide be generally smooth for the occupant to impact, as shown in FIG. 2B. By consistently inflating to the inflated position, the panel 20 may provide increased coverage to the occupant.

The vehicle 10 may, for example, be any suitable type of automobile. As shown in FIGS. 2A-2C, the vehicle 10 includes a passenger cabin 42 to house occupants, if any, of the vehicle 10. The passenger cabin 42 includes one or more front seats 12 disposed at a front of the passenger cabin 42 and one or more rear seats (not numbered) spaced from the front seats 12. The rear seats may be, for example, disposed behind the front seats 12 in the passenger cabin 42. The passenger cabin 42 may also include third-row seats (not shown) at a rear of the passenger cabin 42, in which case the front seats 12 may be second-row seats (not numbered) instead of or in addition to being front seats 12. The front seats 12 and the rear seats may be a same or different type of seat. The front seats 12 and rear seats may be any suitable type of seats.

The reaction surface 14 may be a rigid surface that supports the airbag assembly 16, and specifically, supports the airbag 18 when the airbag 18 is in the inflated position. The airbag assembly 16 may be mounted to the reaction surface 14, as set forth below. When the airbag 18 is in the inflated position, the reaction surface 14 may provide a counteracting force against the airbag 18 when the airbag 18 is impacted by the head of the occupant such that the airbag 18 is squeezed between the head of the occupant and the reaction surface 14.

As one example, the reaction surface 14 may be an instrument panel 44, as shown in FIGS. 2A-2C. Specifically, the reaction surface 14 may be a frame beam (not shown) of the instrument panel 44. As another example, the reaction surface 14 may be a steering wheel. As another example, the reaction surface 14 may be a seatback (not numbered) of the front seat 12. In these examples, the airbag 18 may be inflatable from the reaction surface 14 in the vehicle fore-and-aft direction D. In the alternative to the examples above, the reaction surface 14 may be any suitable surface in the vehicle 10.

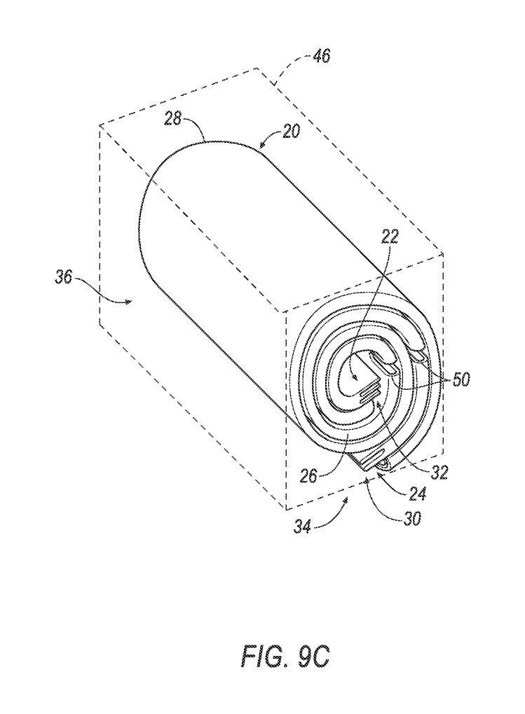

The airbag assembly 16 may include a base 46, i.e., a housing, mounted to the reaction surface 14, e.g., the instrument panel 44, and support the airbag 18, as shown in FIGS. 9A-9C. The base 46 may be flat. As another example, the base 46 may include a cavity (not shown) that may house the airbag 18 in the storage position and may support the airbag 18 on the reaction surface 14, e.g., the instrument panel 44, in the inflated position. The base 46 may, for example, include clips, panels, etc. for attaching the panel 20 and for attaching the airbag 18 to the instrument panel 44.

The airbag 18 may be any suitable type of airbag 18. For example, the airbag 18 may be a front seat passenger airbag, as shown in FIGS. 2A-2C. As another example, the airbag 18 may be a driver airbag, a curtain airbag, a side airbag, a knee airbag, or any other suitable type of airbag.

With reference to FIG. 3, the airbag 18 may include a lateral axis L extending transverse to the axis A. For example, the one side 26 may be spaced from the other side 28 along the lateral axis L. In other words, the top 22 and the bottom 24 of the panel 20, i.e., the first stack of pleats 30 and the second stack of pleats 32, may extend along the lateral axis L.

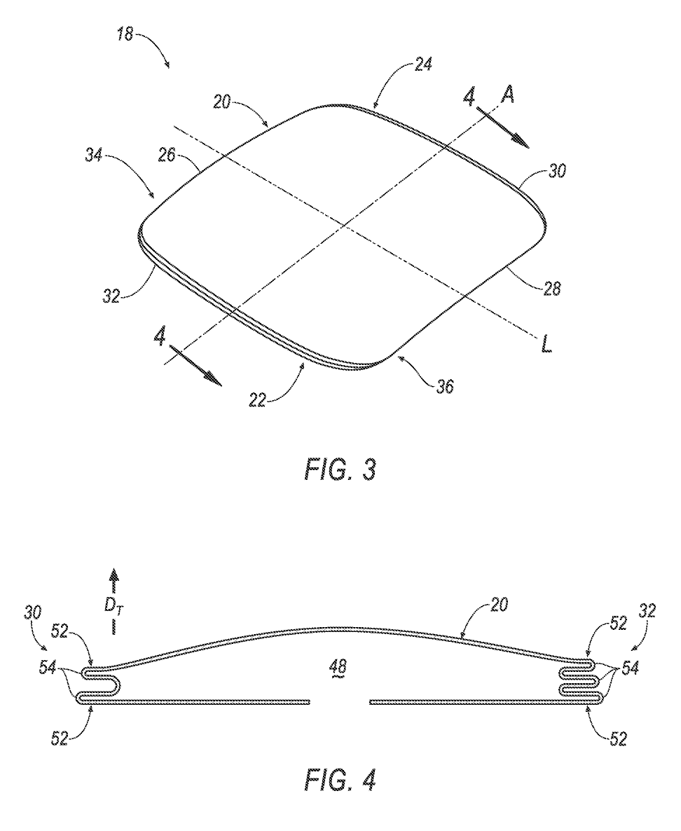

With reference to FIG. 4, the airbag 18, e.g., the panel 20, may define an inflation chamber 48. During inflation, the inflation chamber 48 may be inflated from the storage position to the inflated position. The airbag 18 may include vents 50 extending through the panel 20 to the inflation chamber 48. The vents 50 may be disposed on the sides 26, 28 of the panel 20 such that the vents 50 may be open to the atmosphere. In other words, the inflation chamber 48 may be in communication with the atmosphere through the vents 50. The vents 50 may be any suitable shape, e.g., circular, rectangular, etc., and any suitable number of vents 50 me be disposed one each side 26, 28 of the panel 20.

The airbag 18, e.g., the panel 20, may be monolithic, e.g., a single piece of fabric. As another example, the airbag 18 may include a plurality of segments, i.e., two or more, that are separately formed and subsequently attached together. The segments may be attached to each other in any suitable fashion, e.g., stitching, ultrasonic welding, etc.

The airbag 18 may be formed of any suitable type of material or materials. The airbag 18 may be formed of any suitable airbag material, for example, a woven polymer. For example, the airbag 18 may be formed of woven nylon yarn, for example, nylon 6-6. Other suitable examples include polyether ether ketone (PEEK), polyetherketoneketone (PEKK), polyester, or any other suitable polymer. The woven polymer may include a coating, such as silicone, neoprene, urethane, and so on. For example, the coating may be polyorgano siloxane.

The panel 20 may be foldable from an uninflated position, i.e., a pre-assembly position, as shown in FIG. 3, to the storage position. In the uninflated position, the inflation chamber 48 may be uninflated, and the panel 20 may lack the first fold 38 and the second fold 40. For example, in the uninflated position, the panel 20 may extend generally in a plane (not numbered) along both the axis A and the lateral axis L, as shown in FIG. 3. In this situation, the panel 20 may be thin in a direction Dt transverse to both the axis A and the lateral axis L. In other words, the panel 20 may extend a greater amount along the axis A, i.e., from the top 22 to the bottom 24, and the lateral axis L, i.e., from one side 26 to the other side 28, than in the direction Dt. The panel 20 may terminate at the top 22, bottom 24, and the sides 26, 28. The panel 20 may have any suitable shape, e.g., rectangular, circular, etc.

In the storage position, the top 22 of the panel may be folded into the second stack of pleats 32 and the bottom 24 of the panel 20 may be folded into the first stack of pleats 30. Alternatively, the first stack of pleats 30 and the second stack of pleats 32 may be sewn into the bottom 24 and the top 22 of the panel, respectively, in the uninflated position. The pleats 52 of the first stack of pleats 30 may be stacked on each other, and the pleats 52 of the second stack of pleats 32 may be stacked on each other. In the uninflated position, the pleats 52 of the first stack of pleats 30 may be spaced from each other in the direction Dt, as shown in FIG. 4. In the uninflated position, the pleats 52 of the second stack of pleats 32 may be spaced from each other in the direction Dt, as shown in FIG. 4. The pleats 52 of the first stack of pleats 30 and the second stack of pleats 32 may be spaced from each other the same or a different amount. The pleats 52 of the first stack of pleats 30 and the second stack of pleats 32 may be spaced any suitable amount from each other along the direction Dt.

With reference to FIG. 4, the first stack of pleats 30 and the second stack of pleats 32 may include a same or different number of pleats. The first stack of pleats 30 and the second stack of pleats 32 may each include any suitable number of pleats. For example, the first stack of pleats 30 may include two pleats and the second stack of pleats 32 may include three pleats. In other words, the airbag may include five pleats. The first stack of pleats 30 and the second stack of pleats 32 may each include a distal end 54 spaced from the top 22 and the bottom 24 of the panel 20, respectively. For example, each distal end 54 may be spaced from one of the top 22 and the bottom 24 of the panel 20 along the axis A. In other words, each pleat may extend along the axis A from one of the top 22 and the bottom 24 of the panel 20 to the distal end 54. Each pleat may extend any suitable amount along the axis A.

The first portion 34 and the second portion 36 may be mirror images of each other about the axis A, as shown in the Figures. The first portion 34 and the second portion 36 may each extend along the axis A from the top 22 to the bottom 24 of the panel 20, as shown in FIG. 3. In other words, the first stack of pleats 30 and the second stack of pleats 32 may each extend across the first portion 34 and the second portion 36 of the panel 20. The first portion 34 and the second portion 36 extend in opposite directions from the axis A. For example, the first portion 34 may extend in a first direction D1 along the lateral axis L, i.e., from the axis A to the one side 26, and the second portion 36 may extend in a second direction D2 along the lateral axis L, i.e., from the axis A to the other side 28.

The first portion 34 and the second portion 36, e.g., the panel 20, may be folded in any suitable manner in the storage position. For example, the first portion 34 and the second portion 36 may each have accordion folds in the storage position. In other words, a subsequent fold, e.g., the second fold 40, may be folded in an opposite direction as a previous fold, e.g., the first fold 38. The first portion 34 and the second portion 36, e.g., the panel 20, may be folded along any suitable number of folds. For example, the first portion 34 and the second portion 36 each may be folded along the first fold 38 and the second fold 40, as set forth above. As another example, the first portion 34 and the second portion 36 each may be folded along additional folds, e.g., a third fold and a fourth fold.

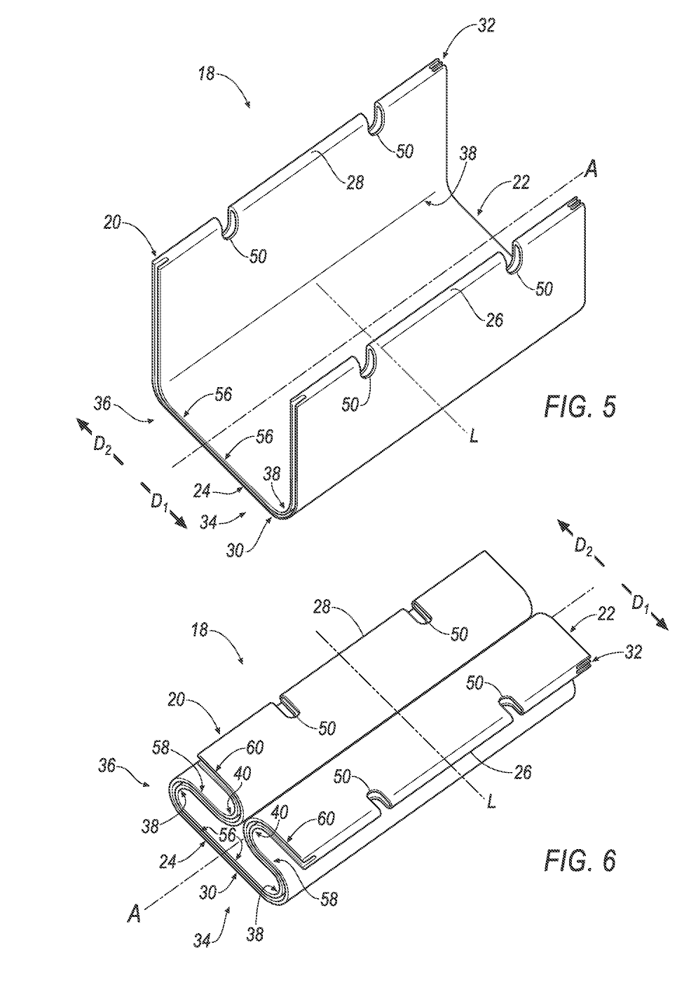

The first fold 38 of the first portion 34 and the first fold 38 of the second portion 36 may be mirror images of each other about the axis A, as shown in the Figures. The first fold 38 of the first portion 34 and the first fold 38 of the second portion 36 may each extend from the top 22 to the bottom 24 of the panel 20, as shown in FIG. 5. In other words, the first fold 38 of the first portion 34 and the first fold 38 of the second portion 36 may each extend across the first stack of pleats 30 and the second stack of pleats 32. The first fold 38 of each portion 34, 36 may be disposed along the lateral axis L between the axis A and the side of the panel 20, as shown in FIG. 5. The first fold 38 of each portion 34, 36 may be disposed at any suitable position along the lateral axis L.

The first fold 38 of each portion 34, 36 may be concave relative to the axis A. For example, the first fold 38 may face the axis A. In other words, after each portion 34, 36 is folded along the first fold 38, each portion 34, 36 may extend from the first fold 38 towards the axis A, as set forth further below.

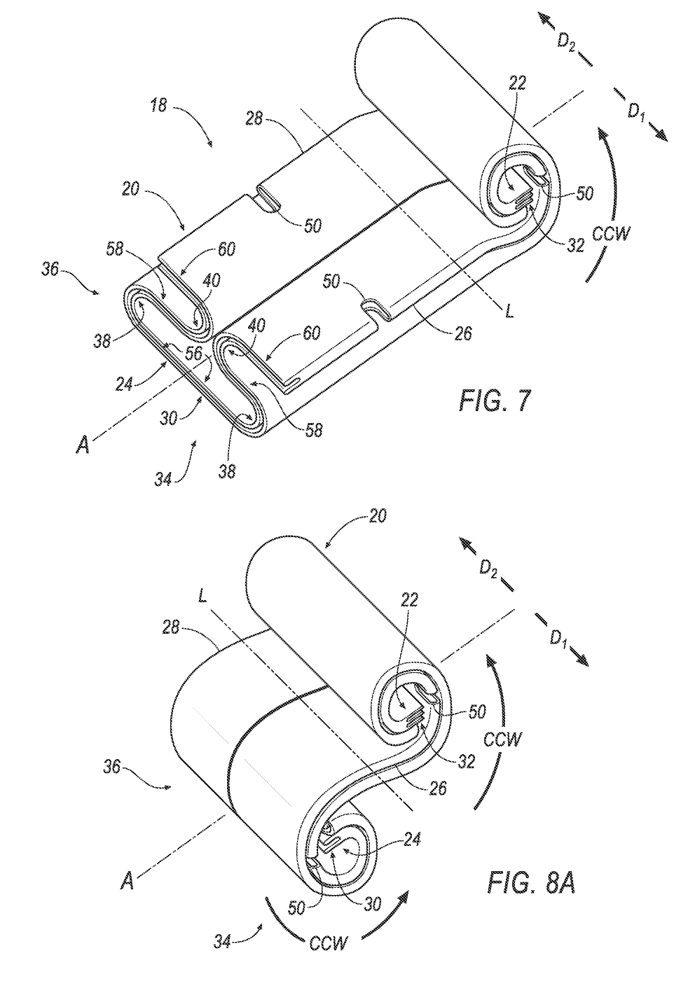

The second fold 40 of the first portion 34 and the second fold 40 of the second portion 36 may be mirror images of each other about the axis A, as shown in the Figures. The second fold 40 of the first portion 34 and the second fold 40 of the second portion 36 may each extend from the top 22 to the bottom 24 of the panel 20, as shown in FIG. 6. In other words, the second fold 40 of the first portion 34 and the second fold 40 of the second portion 36 may each extend across the first stack of pleats 30 and the second stack of pleats 32. The second fold 40 of each portion 34, 36 may be disposed along the lateral axis L between the first fold 38 of each portion 34, 36 and the side of the panel 20, as shown in FIG. 6. The second fold 40 of each portion 34, 36 may be disposed at any suitable position along the lateral axis L. For example, the second fold 40 of each portion 34, 36 may be adjacent the axis A, i.e., between the axis A and the first fold 38.

The second fold 40 of each portion 34, 36 may be convex relative to the axis A. For example, the second fold 40 may face away from the axis A. In other words, after each portion 34, 36 is folded along the second fold 40, each portion 34, 36 may extend from the second fold 40 away from the axis A, as set forth further below.

With reference to FIG. 6, each of the first portion 34 and the second portion 36 may include a first segment 56 extending along the lateral axis L from the axis A to the first fold 38, a second segment 58 extending along the lateral axis L from the first fold 38 to the second fold 40, and a third segment 60 extending along the lateral axis L from the second fold 40 to the third fold. The second segment 58 of each portion 34, 36 may be sandwiched between the first segment 56 and the third segment 60.

With continued reference to FIG. 6, the first segment 56 and the third segment 60 of each portion 34, 36 may extend in the same direction. For example, the first segment 56 and the third segment 60 of the first portion 34 may each extend in the first direction D1. As another example, the first segment 56 and the third segment 60 of the second portion 36 may each extend in the second direction D2. The second segment 58 of each portion 34, 36 may extend in the opposite direction of the first segment 56 and the third segment 60 of each portion 34, 36. For example, the second segment 58 of the first portion 34 may extend in the second direction D2. As another example, the second segment 58 of the second portion 36 may extend in the first direction D1.

Each portion 34, 36 may be folded such that the vents 50 on the sides 26, 28 are in any suitable position in the storage position. For example, the vents 50 may be disposed on the third segment 60 of each portion 34, 36 and face away from the panel 20 in any suitable direction, e.g., the first direction D1, the second direction D2, the direction Dt, etc., as shown in FIG. 6. Alternatively, the vents 50 may be disposed on the third segment 60 of each portion 34, 36 and face the second segment 58 of each portion 34, 36.

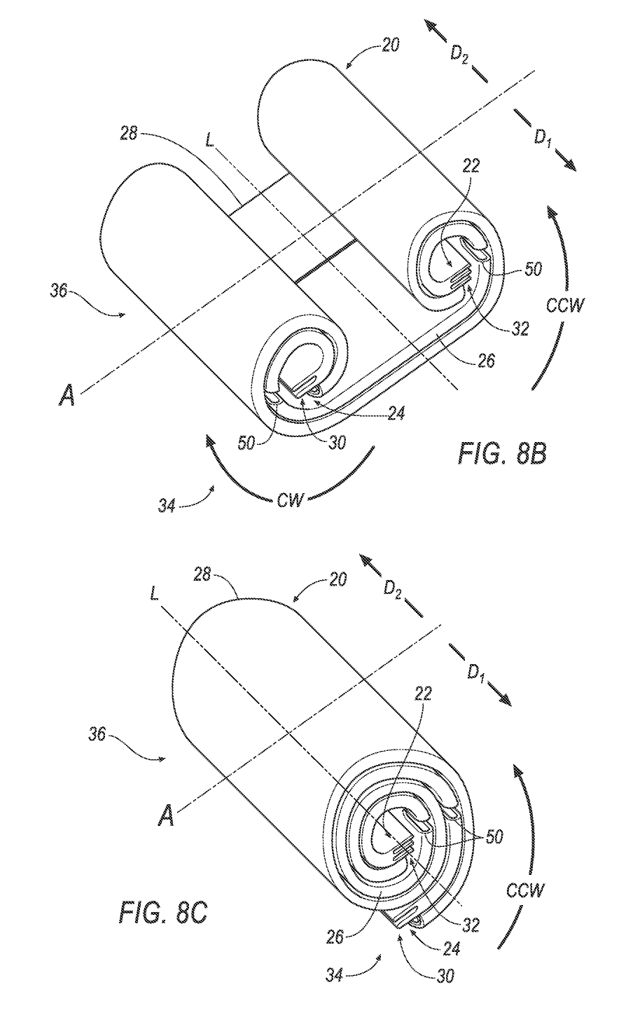

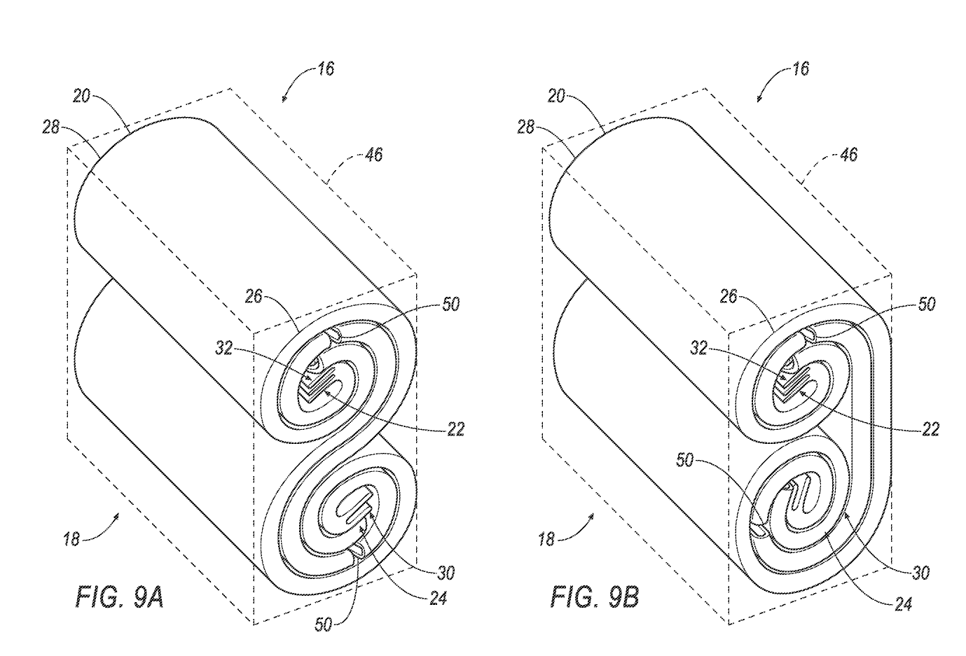

The panel 20 may be rolled in the storage position. Specifically, the top 22 and/or the bottom 24 of the panel 20 may be rolled along the axis A, i.e., about the lateral axis L. When only one of the top 22 and the bottom 24 is rolled, one of the top 22 and the bottom 24 may be rolled along the axis A, i.e., about the lateral axis L, to the other of the top 22 and the bottom 24, as shown in FIGS. 8C and 9C. When the top 22 and the bottom 24 are both rolled along the axis A, the top 22 of the panel 20 may be rolled along the axis A towards the bottom 24 of the panel 20, as shown in FIGS. 7-8C, and the bottom 24 of the panel 20 may be rolled along the axis A towards the top 22 of the panel 20, as shown in FIGS. 8A and 8B.

The top 22 and the bottom 24 may each be rolled any suitable amount along the axis A. For example, the top 22 and the bottom 24 may each be rolled along the axis A to the lateral axis L. In other words, the top 22 and the bottom 24 may converge at the lateral axis L when both the top 22 and the bottom 24 are rolled.

The top 22 and the bottom 24 of the panel 20 may be rolled in the same rotational direction along the axis A. For example, the top 22 and the bottom 24 may both be rolled counterclockwise CCW about the lateral axis L, as shown in FIGS. 8A and 9A. Alternatively, the top 22 and the bottom 24 may be rolled in opposite rotational directions along the axis A. For example, the top 22 may be rolled counterclockwise CCW about the lateral axis L and the bottom 24 may be rolled clockwise CW about the lateral axis L, as shown in FIGS. 8B and 9B.

The airbag assembly 16 may include an inflator 62 in fluid communication with the airbag 18, e.g., the panel 20, that inflates the airbag 18 from the storage position to the inflated position. The inflator 62 expands the airbag 18, e.g., the panel 20, with an inflation medium, such as a gas, to move the airbag 18 from the storage position to the inflated position. Specifically, the inflator 62 may be in communication with the inflation chamber 48 to supply the inflation medium to the inflation chamber 48. The inflator 62 may be supported by the reaction surface 14, e.g., the instrument panel 44 20, as shown in FIG. 2A, or may be disposed in any other suitable location. Alternatively, the inflator 62 may be supported by the base 46.

The inflator 62 may be, for example, a pyrotechnic inflator that uses a chemical reaction to drive the inflation medium into the airbag 18. Alternatively, the inflator 62 may be, for example, a cold-gas inflator that, when activated, ignites a pyrotechnic charge that creates an opening for releasing the pressurized inflation medium to the airbag 18 via a fill tube (not shown). Alternatively, the inflator 62 may be of any suitable type, for example, a hybrid inflator.

The vehicle 10 may include an inflation system (not shown). The inflation system includes a processor (not shown) programmed to initiate an inflation of the airbag 18 in response to the vehicle impact. The processor may be embedded in a microcontroller. The microcontroller may include memory, etc. The memory of the microcontroller may store instructions executable by the processor and the processor may read the instructions from the memory and execute the instructions.

The vehicle 10 may include impact detection sensors (not shown) programmed to detect the vehicle impact to the vehicle 10. The impact detection sensors may be disposed in the instrument panel 44 or elsewhere in the vehicle 10. The impact detection sensors may be of various types, e.g., pressure sensor, acceleration sensor, vision sensor, etc. When the vehicle impact occurs, the processor may receive one or more signals from the impact detection sensors indicating the vehicle impact. In response to receiving the signals from the impact detection sensors, the processor may initiate the inflation of the airbag 18. Alternatively, the processor may initiate the inflation of the airbag 18 selectively based on information from the impact detection sensors identifying the physical characteristics of the vehicle impact, e.g., which side of the vehicle 10 impacted, amount of pressure applied to the vehicle 10, etc. and also seat occupancy information, e.g., by using the occupancy sensors disposed inside the seats 12 sensing the occupancy status of the seats 12.

In order to receive the signals from the impact detection sensors and to initiate the inflation of the airbag 18, the processor communicates with the impact detection sensors and the inflator 62, e.g., through a direct electrical wiring, through which an analog or a digital signal is transmitted, or through a communication network like CAN (Control Area Network), Ethernet, LIN (Local Interconnect Network) or any other way.

In operation, the airbag 18 is in the storage position, as shown in FIG. 2A, under normal operating conditions of the vehicle 10. When the impact detection sensors sense an impact of the vehicle 10, the processor triggers the inflator 62 to inflate the airbag 18 with the inflation medium from the storage position to the inflated position. When the inflator 62 inflates the airbag 18 to the inflated position, the inflation medium flows to the inflation chamber increasing the pressure in the inflation chamber. As the pressure is increased in the inflation chamber, the panel 20 unfolds and extends towards the occupant to the inflated position. Specifically, the top 22 and/or the bottom 24 of the panel 20 may unroll along the axis A. Additionally, the first portion 34 and the second portion 36 of the panel 20 may extend along the lateral axis L in the first direction D1 and the second direction D2, respectively, i.e., in opposite directions. For example, each of the first fold 38 and the second fold 40 of each of the first portion 34 and the second portion 36 may unfold. In other words, the second segment 58 of each portion 34, 36 may rotate about the first fold 38 away from the axis A such that each segment, i.e., the first segment 56, the second segment 58, and the third segment 60, of each portion 34, 36 may be aligned along the lateral axis L. During inflation, the panel 20 may unfold consistently, i.e., in the same manner and shape, such that the panel 20 provides predictable and increased coverage to the occupant. Since the occupant may impact the panel 20 prior to full deployment of the airbag 18, i.e., prior to the airbag 18 reaching the inflated position, the consistent deployment of the panel 20 may allow the airbag 18 to be positioned in the vehicle 10 such that the occupant may receive maximum coverage from the airbag 18 when the occupant impacts the airbag 18, which may reduce the likelihood of injury to the occupant during the vehicle impact.

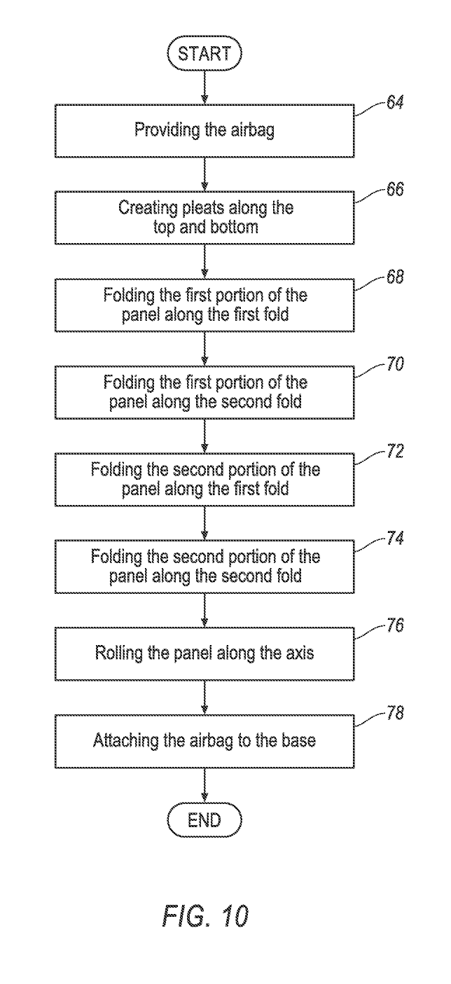

A method for folding the panel 20 is shown in FIG. 10. The method may be used to fold the panel 20 from the uninflated position to the storage position. For example, the method may be performed to fold the panel 20 and attach the airbag 18 to the base 46. In other words, the method may be used to assemble the airbag assembly 16. The method may be performed to meet the packaging requirements of the vehicle 10 and ensure consistent deployment, i.e., inflation, of the airbag 18 from the storage position to the inflated position.

As shown in block 64, the method includes providing the airbag 18. The airbag 18 may be in the uninflated position and arranged such that the panel 20 is stretched out along both the axis A and the lateral axis L. In other words, the panel 20 may be taut from the top 22 to the bottom 24, i.e., along the axis A, and from one side 26 to the other side 28, i.e., along the lateral axis L.

As shown in block 66, the method includes creating pleats 52, 54 along the top 22 and the bottom 24 of the panel 20. For example, the pleats 52 of the first stack of pleats 30 may be folded into the bottom 24 of the panel 20, and the pleats 54 of the second stack of pleats 32 may be folded into the top 22 of the panel. Alternatively, the pleats 52, 54 may be sewn into the bottom 24 and the top 22 of the panel, respectively, in the uninflated position. As set forth above, the pleats 52, 54 may extend across the panel 20 from one side 26 to the other side 28 along the bottom 24 and the top 22, respectively.

As shown in block 68, the method includes folding the first portion 34 of the panel 20 along the first fold 38 towards the axis A. By folding the first portion 34 along the first fold 38, the first portion 34 of the panel 20 is rotated about the axis A at the first fold 38 such that the one side 26 of the panel 20 is rotated about the first fold 38 towards the axis A. In this situation, the second segment 58 of the first portion 34 may extend across the first segment 56 of the first portion 34 from the first fold 38 towards the axis A. As set forth above, the first fold 38 may extend from the top 22 to the bottom 24 of the panel 20 and be disposed at any suitable position between the axis A and the one side 26 of the panel 20, i.e., along the lateral axis L. In other words, the first segment 56 of the first portion 34 may extend any suitable amount in the first direction D1.

As shown in block 70, after folding the first portion 34 along the first fold 38, the method includes folding the first portion 34 of the panel 20 along the second fold 40 away from the axis A. By folding the first portion 34 along the second fold 40, the first portion 34 of the panel 20 is rotated about the axis A at the second fold 40 such that the one side 26 of the panel 20 is rotated about the second fold 40 away from the axis A. In this situation, the third segment 60 of the first portion 34 may extend across the second segment 58 of the first portion 34 from the second fold 40 to the one side 26 of the panel 20. As set forth above, the second fold 40 may extend from the top 22 to the bottom 24 of the panel 20 and be disposed at any suitable position between the first fold 38 and the one side 26 of the panel 20, i.e., along the lateral axis L. In other words, the second segment 58 of the first portion 34 may extend any suitable amount in the second direction D2. In this situation, the third segment 60 of the first portion 34 may extend from the second fold 40 in the first direction D1 to the one side 26 of the panel 20. When the first portion 34 is folded, the vents 50 on the one side 26 of the panel 20 may face in the first direction D1.

As shown in block 72, the method includes folding the second portion 36 of the panel 20 along the first fold 38 towards the axis A. By folding the second portion 36 along the first fold 38, the second portion 36 of the panel 20 is rotated about the axis A at the first fold 38 such that the other side 28 of the panel 20 is rotated about the first fold 38 towards the axis A. In this situation, the second segment 58 of the second portion 36 may extend across the first segment 56 of the second portion 36 from the first fold 38 towards the axis A. As set forth above, the first fold 38 may extend from the top 22 to the bottom 24 of the panel 20 and be disposed at any suitable position between the axis A and the other side 28 of the panel 20, i.e., along the lateral axis L. In other words, the first segment 56 of the second portion 36 may extend any suitable amount in the second direction D2.

As shown in block 74, after folding the second portion 36 along the first fold 38, the method includes folding the second portion 36 of the panel 20 along the second fold 40 away from the axis A. By folding the second portion 36 along the second fold 40, the second portion 36 of the panel 20 is rotated about the axis A at the second fold 40 such that the other side 28 of the panel 20 is rotated about the second fold 40 away from the axis A. In this situation, the third segment 60 of the second portion 36 may extend across the second segment 58 of the second portion 36 from the second fold 40 to the other side 28 of the panel 20. As set forth above, the second fold 40 may extend from the top 22 to the bottom 24 of the panel 20 and be disposed at any suitable position between the first fold 38 and the other side 28 of the panel 20, i.e., along the lateral axis L. In other words, the second segment 58 of the second portion 36 may extend any suitable amount in the first direction D1. In this situation, the third segment 60 of the second portion 36 may extend from the second fold 40 in the second direction D2 to the other side 28 of the panel 20. When the second portion 36 is folded, the vents 50 on the other side 28 of the panel 20 may face in the second direction D2.

As shown in block 76, after folding the first portion 34 and the second portion 36 of the panel 20, the method includes rolling the panel 20 along the axis A. For example, top 22 of the panel 20 may be rolled towards the bottom 24 of the panel 20 along the axis A, as shown in FIG. 7. The top 22 of the panel 20 may be rolled along the axis A, i.e., about the lateral axis L, any suitable amount. For example, the top 22 of the panel 20 may be rolled along the axis A to the lateral axis L. Alternatively, the top 22 of the panel 20 may be rolled along the axis A to the bottom 24 of the panel 20, as shown in FIGS. 8C and 9C. The top 22 of the panel 20 may be rolled in any suitable rotational direction. For example, the top 22 of the panel 20 may be rolled counterclockwise CCW, as set forth above. Alternatively, the top 22 of the panel 20 may be rolled clockwise CW.

When the top 22 of the panel 20 is rolled partially to the bottom 24 of the panel 20, the bottom 24 of the panel 20 may be rolled towards the top 22 of the panel 20 along the axis A, i.e., about the lateral axis L. The bottom 24 of the panel 20 may be rolled along the axis A such that the bottom 24 of the panel 20 converges with the top 22 of the panel 20. For example, each of the bottom 24 and the top 22 of the panel 20 may be rolled to the lateral axis L. The bottom 24 of the panel 20 may be rolled in a same or different rotational direction as the top 22 of the panel 20. For example, the bottom 24 of the panel 20 may be rolled counterclockwise CCW about the lateral axis L when the top 22 of the panel 20 is rolled counterclockwise CCW about the lateral axis L, as shown in FIGS. 8A and 9A. Alternatively, the bottom 24 of the panel 20 may be rolled clockwise CW about the lateral axis L when the top 22 of the panel 20 is rolled counterclockwise CCW about the lateral axis L, as shown in FIGS. 8B and 9B.

As shown in block 78, after rolling the airbag 18, the method includes attaching the airbag 18 to the base 46. The base 46 may include clips, panels, etc. for attaching the airbag 18, as set forth above. After attaching the airbag 18 to the base 46, the method is completed and the completed airbag assembly 16 may be stored for transportation.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. An airbag comprising:
a panel foldable to a storage position;
the panel including a top, a bottom spaced from the top along an axis, and sides spaced from each other and extending from the top to the bottom;
the panel including a first stack of pleats extending from one of the sides to the other of the sides along the top, and a second stack of pleats extending from one of the sides to the other of the sides along the bottom; and
the panel including a first portion extending from the axis to one side and a second portion extending from the axis to the other side, the first portion and the second portion, in the storage position, each folded along a first fold towards the axis and along a second fold away from the axis.

2. The airbag of claim 1, wherein the top of the panel is rolled along the axis towards the bottom of the panel.

3. The airbag of claim 2, wherein the bottom of the panel is rolled along the axis towards the top of the panel.

4. The airbag of claim 3, wherein the top and the bottom of the panel are rolled in the same rotational direction along the axis.

5. The airbag of claim 3, wherein the top and the bottom of the panel are rolled in opposite rotational directions along the axis.

6. The airbag of claim 1, wherein each of the first folds and each of the second folds extend along the axis from the top to the bottom of the panel.

7. The airbag of claim 1, wherein the second fold of the first portion is disposed between the first fold of the first portion and one side, and the second fold of the second portion is disposed between the first fold of the second portion and the other side.

8. The airbag of claim 1, wherein in the storage position, the first portion and the second portion each include a first segment extending from the axis to the first fold, a second segment extending from the first fold to the second fold, and a third segment extending from the second fold away from the axis.

9. The airbag of claim 8, wherein the second segment is sandwiched between the first segment and the third segment.

10. The airbag of claim 1, further comprising vents disposed on each side of the panel.

11. A method comprising:
providing an airbag having a panel including a top, a bottom spaced from the top along an axis, and sides spaced from each other and extending from the bottom to the top, the panel including a first stack of pleats extending from one side to the other side along the top and a second stack of pleats extending from one side to the other side along the bottom;
folding a first portion of the panel towards the axis along a first fold disposed between the axis and one side, and folding the first portion of the panel away from the axis along a second fold disposed between the first fold and one side;
folding a second portion of the panel towards the axis along a first fold disposed between the axis and other side, and folding the second portion of the panel away from the axis along a second fold disposed between the first fold and other side.

12. The method of claim 11, further comprising rolling the top of the panel along the axis towards the bottom of the panel.

13. The method of claim 12, further comprising rolling the bottom of the panel along the axis towards the top of the panel.

14. The method of claim 13, wherein the top of the panel and the bottom of the panel are rolled in the same rotational direction along the axis.

15. The method of claim 13, wherein the top of the panel and the bottom of the panel are rolled in opposite rotational directions along the axis.

16. The method of claim 11, wherein the first fold and the second fold of each of the first portion and the second portion are spaced from each other transverse to the axis.

17. The method of claim 11, wherein each of the first folds and each of the second folds extend along the axis from the top to the bottom.

18. The method of claim 11, wherein the first portion and the second portion each include a first segment extending from the axis to the first fold, a second segment extending from the first fold to the second fold, and a third segment extending from the second fold away from the axis.

19. The method of claim 18, wherein the second segment is sandwiched between the first segment and the third segment.

20. The method of claim 11, wherein the airbag includes vents disposed on each side of the panel.
